(19) United States
(12) Patent Application Publication
(10) Pub. No.: US 2022/0058368 A1
(43) Pub. Date: Feb. 24, 2022

(54) Fingerprint Identification Method by Using Electronic Device and the Electronic Device Thereof

(71) Applicant: InnoLux Corporation, Miao-Li County (TW)

(72) Inventors: Kuei-Sheng CHANG, Miao-Li County (TW); Kuo-Jung WU, Miao-Li County (TW); Po-Yang CHEN, Miao-Li County (TW); I-An YAO, Miao-Li County (TW)

(73) Assignee: InnoLux Corporation, Miao-Li County (TW)

(21) Appl. No.: 17/373,804

(22) Filed: Jul. 13, 2021

(30) Foreign Application Priority Data
Aug. 18, 2020 (CN) 202010832248.X

(51) Int. Cl. G06K 9/00; G06F 3/041; G09G 3/20

(52) U.S. Cl. CPC G06K 9/00087; G06K 9/0002; G09G 2310/0267; G09G 3/20; G06F 3/04184

(57) ABSTRACT

A fingerprint identification method includes partitioning a plurality of readout lines of the electronic device into at least two groups, receiving a signal, determining a finger touch region according to the signal, and simultaneously enabling a portion of readout lines of each group corresponding to the finger touch region of the at least two groups.

### BACKGROUND OF THE DISCLOSURE

### 1. Field of the Disclosure

The present disclosure illustrates a fingerprint identification method and the electronic device capable of identifying a fingerprint, and more particularly, a fingerprint identification method and an electronic device capable of identifying the fingerprint for reducing a scan count.

### 2. Description of the Prior Art

With the rapid development of technology, various touch panels, touch display panels, and touch screens are also widely used in daily life. Moreover, with the requirement of full-screen mobile phones, the requirement of artificial intelligence, and the requirement of the appearance of mobile phones, screen-based fingerprint unlocking method becomes a popular method for unlocking mobile phones. A goal of current mobile phone design is to provide fast and accurate fingerprint identification and positioning fingerprint functions.

Currently, the fingerprint can only be unlocked in a specific or fixed region of the phone screen. The mobile phone must scan the specific region repeatedly for collecting fingerprint data to identify the fingerprint. Therefore, when a resolution or a size of the phone screen is high, the conventional fingerprint unlocking process may lead to a high-latency of touching operation. Since the high-latency of touching operation is introduced, the touching operation experience for a user is decreased. Further, it will also consume a lot of power so that the working time of the mobile phone is shortened.

### SUMMARY OF THE DISCLOSURE

In an embodiment of the present disclosure, a fingerprint identification method by using an electronic device is disclosed. The fingerprint identification method comprises partitioning a plurality of readout lines of the electronic device into at least two groups, receiving a signal, determining a finger touch region according to the signal, and simultaneously enabling a portion of readout lines of each group corresponding to the finger touch region of the at least two groups.

In another embodiment of the present disclosure, an electronic device capable of identifying a fingerprint is disclosed. The electronic device comprises a touch panel, a plurality of scan lines, a plurality of readout lines, a plurality of driving circuits, and a fingerprint identification readout circuit. The plurality of scan lines are coupled to the touch panel. The plurality of readout lines are coupled to the touch panel. The plurality of driving circuits are coupled to the plurality of readout lines and configured to selectively output fingerprint information. The fingerprint identification readout circuit is coupled to the plurality of driving circuits and configured to identify a fingerprint. The plurality of readout lines are partitioned into at least two groups. The fingerprint identification readout circuit determines a finger touch region according to a signal after the fingerprint identification readout circuit receives the signal. The fingerprint identification readout circuit simultaneously enables a portion of readout lines of each group corresponding to the finger touch region of the at least two groups.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a block diagram of an electronic device capable of identifying a fingerprint according to an embodiment of the present disclosure.

FIG. 2 is an illustration of partitioning readout lines by using a first method, and then reading out fingerprint information by using a fingerprint identification readout circuit of the electronic device in FIG. 1.

FIG. 3 is an illustration of partitioning the readout lines by using a second method, and then reading out the fingerprint information by using the fingerprint identification readout circuit of the electronic device in FIG. 1.

FIG. 4 is an illustration of controlling driving circuits located on different regions of a touch panel by using control signals of the electronic device in FIG. 1.

FIG. 5 is an illustration of first waveforms of the control signal and scan line signals of the electronic device in FIG. 1.

FIG. 6 is an illustration of second waveforms of the control signal and scan line signals of the electronic device in FIG. 1.

FIG. 7 is a flow chart of performing a fingerprint identification method by using the electronic device in FIG. 1.

### DETAILED DESCRIPTION

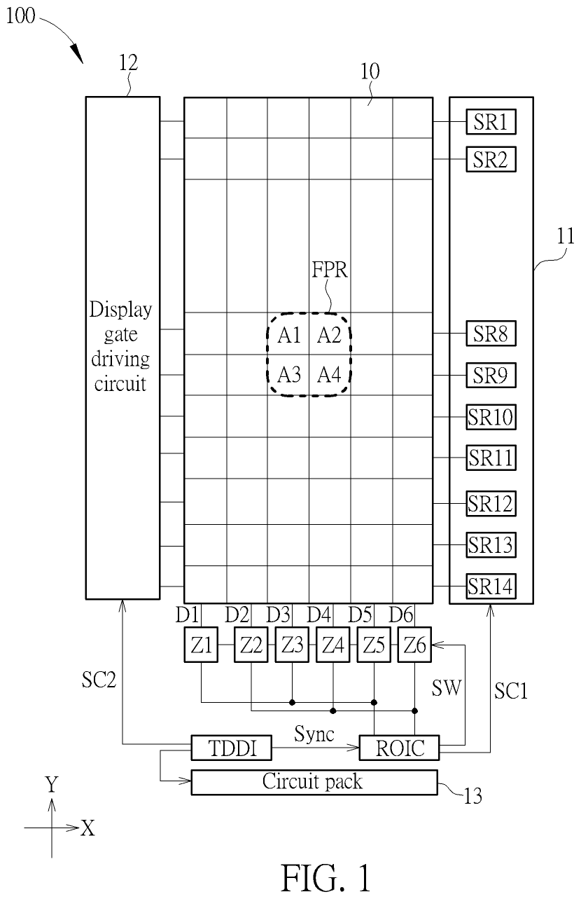

FIG. 1 is a block diagram of an electronic device 100 capable of identifying a fingerprint according to an embodiment of the present disclosure. The electronic device 100 includes a touch panel 10, a plurality of scan line groups SR1 to SR14, a plurality of readout line groups D1 to D6, a plurality of driving circuits Z1 to Z6 (i.e., the driving circuits Z1 to Z6 can be integrated into a multiplexer), and a fingerprint identification readout circuit ROIC. The touch panel 10 of the electronic device 100 may be a touch panel only having a touch function, such as a capacitive touch panel or a resistive touch panel. However, the touch panel 10 of the electronic device 100 may also be a panel having an image display or/and a touch functions. Any reasonable structure of the touch panel 10 falls into the scope of the present disclosure. Further, the electronic device 100 can be applied to a display device, an antenna device, a readout device, or an image splicing device. The electronic device 100 may be a bendable electronic device. The electronic device 100 can include a liquid crystal device and a light-emitting diode (LED) device. For example, the LED device can be an organic light-emitting diode (OLED) device, a mini-LED device, a micro-LED device, a Quantum Dot (QLED, QDLED) device, fluorescence, phosphor, or other suitable materials. The touch panel 10 can be divided into P×Q regions. P and Q are positive integers. In FIG. 1, P=14 (i.e., arranged along the Y-axis), Q=6 (i.e., arranged along the X-axis) are introduced. However, sizes and shapes of the P×Q regions of the touch panel 10 are not limited to a certain configuration. For example, in FIG. 1, each region of the touch panel 10 can correspond to 120 scan lines and 120 readout lines. In other words, a region located on the upper left corner of the touch panel 10 corresponds to the scan line group SR1 and the readout line group D1. Here, the scan line group SR1 may include 120 scan lines. The readout line group D1 may include 120 readout lines. However, in the electronic device 100, the number of scan lines and the number of readout lines corresponding to each region are not limited thereto. In other words, the number of scan lines of the scan line group SRp corresponding to the (p, q) -th region is not limited thereto. Further, the number of readout lines of the corresponding read line group Dq is not limited thereto. The scan lines and readout lines are coupled to the touch panel 10. A plurality of driving circuits Z1 to Z6 are coupled to the readout lines for selectively outputting fingerprint information. In other words, the driving circuits Z1 to Z6 can be regarded as input terminals of a multiplexer. The electronic device 100 can selectively output data corresponding to a specific region of the touch panel 10 for reducing the scan count of the touch panel 10. Details are described later. The fingerprint identification readout circuit ROIC is coupled to the driving circuits Z1 to Z6 for performing a fingerprint identification function. In the electronic device 100, the readout lines can be divided into at least two groups. After the fingerprint identification readout circuit ROIC receives the signal, the fingerprint identification readout circuit ROIC can determine a finger touch region FPR according to the signal. Here, the signal received by the fingerprint identification readout circuit ROIC may be a touch signal. The touch signal can include positioning information of the finger touching the touch panel 10. Further, the finger touch region FPR may include at least two regions. For example, in FIG. 1, the finger touch region FPR may include a region A1, a region A2, a region A3, and a region A4. For example, a single scan line group can include 120 scan lines. A single readout line group can include 120 readout lines. Therefore, when the finger touch region FPR includes the region A1, the region A2, the region A3, and the region A4, it corresponds to a scan line group SR8, a scan line group SR9, a readout line group D3, and a readout line group D4. In other words, the finger touch region FPR in FIG. 1 corresponds to 240 scan lines and 240 readout lines. The fingerprint identification readout circuit ROIC can simultaneously enable a portion of readout lines of each group corresponding to the finger touch region FPR. For example, as previously mentioned, the finger touch region FPR corresponds to the scan line group SR8, the scan line group SR9, the readout line group D3, and the readout line group D4. Since the fingerprint identification readout circuit ROIC can simultaneously enable the readout line group D3 and the readout line group D4, output data of the 240 readout lines can be received simultaneously. The fingerprint identification readout circuit ROIC can generate a control signal SW according to the finger touch region FPR for controlling a portion of the readout lines of each group to be enabled at the same time (for example, readout line groups D3 and D4, a total of 240 readout lines). The fingerprint identification readout circuit ROIC can also generate a control signal SC1 for driving a scan line control circuit 11 to scan the finger touch region FPR. For example, the 240 scan lines of the scan line group SR8 and scan line group SR9 are used for sequentially scanning the finger touch region FPR. In other words, the fingerprint identification readout circuit ROIC can enable scan lines which overlap the finger touch region FPR. After the readout lines corresponding to the finger touch region FPR are enabled for performing a scanning process, the fingerprint identification readout circuit ROIC can read the fingerprint information. Further, the previously mentioned “readout lines” and “scan lines” can be regarded as circuits used for performing the fingerprint identification function. Specifically, the “scan lines” are used for identifying fingerprint features.

When the touch panel 10 of the electronic device 100 is a display touch panel having a display and a touch functions, the electronic device 100 may further include a touch panel driving circuit TDDI, a display gate driving circuit 12, and a circuit pack 13. The circuit pack 13 may include at least one multiplexer and at least one de-multiplexer. The touch panel driving circuit TDDI can control the circuit pack 13 for reducing the number of scan lines used for displaying images. The circuit pack 13 can be coupled to the touch panel driving circuit TDDI. For example, in order to display images, 1080 columns of pixels must be scanned. Therefore, an integrated circuit requires supporting 1080×3 scan lines for performing the image display function. If the circuit pack 13 is introduced, 1080×3 scan lines can be partitioned (for example, they can be divided into 6 groups). Therefore, the 1080×3 scan lines only need to fan out 540 scan lines. The touch panel driving circuit TDDI can generate a synchronization signal Sync to the fingerprint identification readout circuit ROIC. The operation steps of the electronic device 100 are illustrated below. After a finger touches the touch panel 10, the touch panel 10 can acquire a position of the finger. Then, the touch panel 10 can transmit a signal carrying finger position information (i.e., finger coordinates) to the touch panel driving circuit TDDI. Then, the touch panel driving circuit TDDI can transmit the finger position information to the fingerprint identification readout circuit ROIC through a host. The fingerprint identification readout circuit ROIC can use a control signal SW for selecting at least two driving circuits (i.e., such as a driving circuit Z3 and a driving circuit Z4) to enable a part of readout lines. The fingerprint identification readout circuit ROIC can use a control signal SC1 for controlling at least two scan line groups (i.e., such as a scan line group SR8 and a scan line group SR9, 240 scan lines) for scanning the finger touch region FPR. The touch panel driving circuit TDDI can generate a control signal SC2 for controlling the display gate driving circuit 12 to drive a plurality of scan lines. The method of partitioning readout lines of the electronic device 100 and how to control the readout lines which overlap at least two regions are described later.

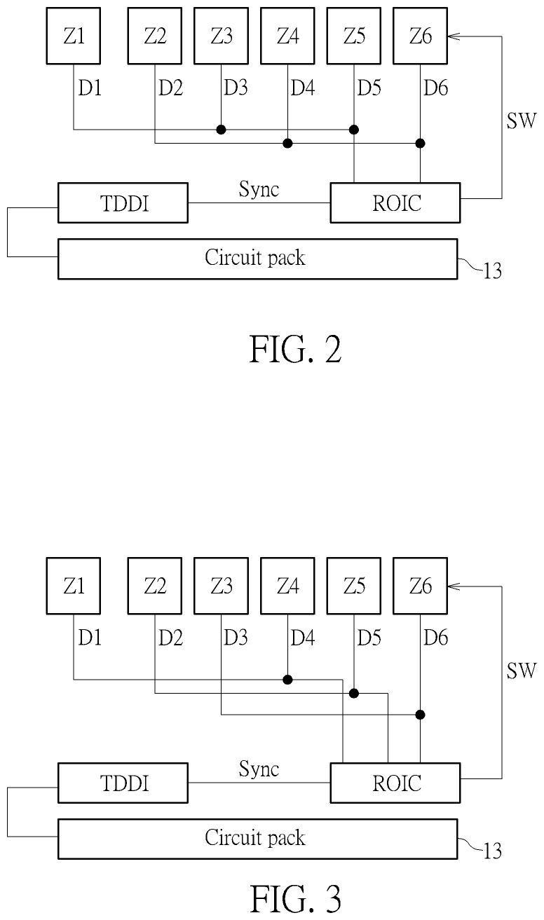

FIG. 2 is an illustration of partitioning readout lines by using a first method, and then reading out fingerprint information by using the fingerprint identification readout circuit ROIC of the electronic device 100. As previous embodiments, each of the readout line groups D1 to D6 includes 120 readout lines. The finger touch region FPR may include 4 regions (i.e., the region A1 to the region A4). The fingerprint identification readout circuit ROIC can collect 240 readout lines at the same time. In other words, the fingerprint identification readout circuit ROIC can collect readout line groups corresponding to two regions at the same time. For example, the region A1 and the region A3 correspond to the readout line group D3. The region A2 and the region A4 correspond to the readout line group D4. In FIG. 2, the readout line groups D1 to D6 can be divided into two sets. The first set includes a readout line group D1, a readout line group D3, and a readout line group D5. The second set includes a readout line group D2, a readout line group D4, and a readout line group D6. Since the readout line group D1, the readout line group D3, and the readout line group D5 belong to the first set, the readout line group D1, the readout line group D3, and the readout line group D5 can be coupled to each other. Similarly, since the readout line group D2, the readout line group D4, and the readout line group D6 belong to the second set, the readout line group D2, the readout line group D4, and the readout line group D6 can be coupled to each other. Further, a readout line group can be selected from the first set including the readout line group D1, the readout line group D3, and the readout line group D5. Similarly, another readout line group can be selected from the second set including the readout line group D2, the readout line group D4, and the readout line group D6, as shown in FIG. 2. The selection process of the readout line groups can be performed by using the multiplexer. In other words, the electronic device 100 can introduce to the multiplexer. The multiplexer can be used for selecting a portion of the readout lines from a plurality of readout lines divided into at least two groups. Therefore, in the original 6 readout line groups (D1 to D6), only two readout line groups are enabled at the same time. For example, when the first set enables the readout line group D1 and the second set enables the readout line group D2, the touch panel 10 of the electronic device 100 can scan two regions at the same time. When the first set enables the readout line group D3 and the second set enables the readout line group D4, the touch panel 10 of the electronic device 100 can scan two regions at the same time. When the first set enables the readout line group D5 and the second set enables the readout line group D6, the touch panel 10 of the electronic device 100 can scan two regions at the same time. In the embodiment of FIG. 1, the finger touch region FPR includes the region A1, the region A2, the region A3, and the region A4. The region A1 and the region A2 are located on the touch panel 10 corresponding to the scan line group SR8 (120 scan lines). The region A3 and the region A4 are located on the touch panel 10 corresponding to the scan line group SR9 (120 scan lines). Therefore, according to the position of the finger touch region FPR, the first set can enable the readout line group D3. The second set can enable the readout line group D4. In other words, in the finger touch region FPR including four regions (A1 to A4), the touch panel 10 can scan two regions at the same time. In other words, the scan count of the finger touch region FPR by using the touch panel 10 is two. Then, the fingerprint identification readout circuit ROIC can acquire all fingerprint information of the finger touch region FPR through the enabled readout line. The fingerprint identification readout circuit ROIC can select one of the three readout line groups in the first set. The fingerprint identification readout circuit ROIC can simultaneously select one of the three readout line groups in the second set. Therefore, for the first set and the second set, it is equivalent that a plurality of readout lines can be coupled to at least one multiplexer. In other words, the at least one multiplexer is used for partitioning the readout lines into at least two groups/sets. Moreover, dimensions of the multiplexer are not limited thereto. In other words, in other embodiments, the first set and the second set can be configured indifferent modes. Details are described later.

FIG. 3 is an illustration of partitioning the readout lines by using a second method, and then reading out the fingerprint information by using the fingerprint identification readout circuit ROIC of the electronic device 100. The electronic device 100 can set the grouping mode. In FIG. 3, the readout line groups D1 to D6 can be divided into three sets. The first set includes readout line group D1 and readout line group D4. The second set includes readout line group D2 and readout line group D5. The third set includes readout line group D3 and readout line group D6. Since the readout line group D1 and the readout line group D4 belong to the first set, the readout line group D1 and the readout line group D4 can be coupled to each other. Similarly, since the readout line group D2 and the readout line group D5 belong to the second set, the readout line group D2 and the readout line group D5 can be coupled to each other. Similarly, since the readout line group D3 and the readout line group D6 belong to the third set, the readout line group D3 and the readout line group D6 can be coupled to each other. Further, the first set can select a readout line group from the readout line group D1 and the readout line group D4. In the second set, another readout line group can be selected from the readout line group D2 and the readout line group D5. In the third set, another readout line group can be selected from the readout line group D3 and the readout line group D6 (i.e., as shown in FIG. 3). Similarly, the selection process can be performed by the multiplexer. In other words, the electronic device 100 can introduce the multiplexer. The multiplexer can be used for selecting a portion of the readout lines from a plurality of readout lines divided into at least two groups. Therefore, in the original 6 readout line groups (D1 to D6), only three readout line groups are enabled at the same time. For example, when the first set enables the readout line group D1 and the second set enables the readout line group D2 and the third set enables the readout line group D3, the touch panel 10 of the electronic device 100 can scan three regions at the same time. When the first set enables the readout line group D4, the second set enables the readout line group D5 and the third set enables the readout line group D6, the touch panel 10 of the electronic device 100 can scan three regions at the same time. If the finger touch region FPR includes the three regions corresponding to the readout line groups D2 to D4, the fingerprint identification readout circuit ROIC can simultaneously enable the readout line group D2 of the second set, the readout line group D3 of the third set, and the readout line group D4 of the first set. In other words, the touch panel 10 can scan three regions at the same time. Since the touch panel 10 can scan at least three regions at the same time, the number of scans can be reduced.

As previously mentioned, in FIG. 2 and FIG. 3, the readout line groups are arranged in an interlaced manner. Further, the readout line groups are arranged at the same interval distance. For example, in FIG. 2, the readout line groups of the first set {D1, D3, D5} and the second set {D2, D4, D6} are arranged in an interlaced manner. In FIG. 3, the readout line groups of the first set {D1, D4}, the second set {D2, D5}, and the third set {D3, D6} are arranged in the interlaced manner. However, the present disclosure is not limited to a specific grouping mode of the readout lines. Any technology modification falls into the scope of the present disclosure. Moreover, after the finger touches the finger touch region FPR, the finger touch region FPR outputs fingerprint information to the fingerprint identification readout circuit ROIC through at least two readout line groups. The fingerprint identification readout circuit ROIC can perform a fingerprint identification process according to the fingerprint information. Further, since the electronic device 100 can scan more than two regions at the same time, it can reduce the number of scans of a traditional scanning mechanism.

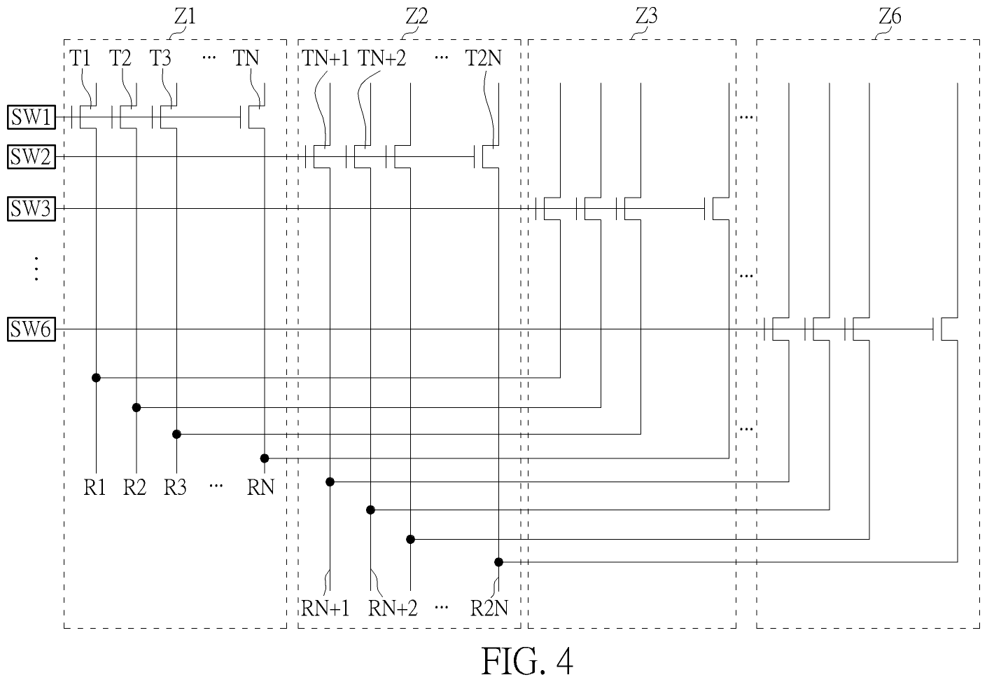

FIG. 4 is an illustration of controlling driving circuits Z1 to Z6 located on different regions of the touch panel 10 by using control signals SW1 to SW6 of the electronic device 100. As previously mentioned, the readout line groups D1 to D6 can be divided into at least two sets. For example, the readout line groups D1 to D6 can be divided into the first set {D1, D3, D5} and the second set {D2, D4, D6}. The fingerprint identification readout circuit ROIC can generate control signals for controlling the driving circuits Z1 to Z6 to enable one readout line group of the first set {D1, D3, D5}, and enable one readout line group of the second set {D2, D4, D6} at the same time. In other words, the driving circuits Z1 to Z6 can be regarded as switches of the multiplexer when signals are selected. Please refer to FIG. 3 and FIG. 4, the driving circuit Z1 includes transistors T1 to TN. The control signal SW1 can control the transistors T1 to TN through gate terminals. N can be 120. It implies that the readout lines R1 to RN of the readout line group D1 can be controlled according to the control signal SW1. When the control signal SW1 is at a high voltage level, the transistors T1 to TN are enabled. Therefore, the fingerprint data carried by the readout lines R1 to RN of the readout line group D1 to be received by the fingerprint identification and readout circuit ROIC. However, any waveform of the control signal used for controlling the readout lines falls into the scope of the present disclosure. Similarly, the driving circuit Z2 includes transistors TN+1 to T2N. The control signal SW2 can control the transistors TN+1 to T2N through gate terminals. N can be 120 (i.e., for example, T121 to T240). It implies that the readout lines RN+1 to R2N of the readout line group D2 can be controlled according to the control signal SW2. When the control signal SW2 is at the high voltage level, the transistors TN+1 to T2N are enabled. Therefore, the fingerprint data carried by the readout lines RN+1 to R2N of the readout line group D2 to be received by the fingerprint identification and readout circuit ROIC, and so on. Further, the transistors T1 to TN or/and the transistors TN+1 to T2N can be N-type Metal-Oxide-Semiconductor Field-Effect Transistor (NMOS), P-type Metal-Oxide-Semiconductor Field-Effect Transistor (PMOS), or Complementary Metal-Oxide-Semiconductor (CMOS). Thus, voltages of the control signal SW1 to the control signal SW6 can be adjusted according to the requirements of the transistors T1 to TN, the transistors TN+1 to T2N, and so on. Any hardware modification falls into the scope of the present disclosure. The control signals SW1 to SW6 generated by the fingerprint identification readout circuit ROIC is used for controlling states of the readout lines through the transistors in the touch panel 10. Therefore, the fingerprint identification readout circuit ROIC can simultaneously acquire fingerprint data corresponding to at least two regions through the readout lines.

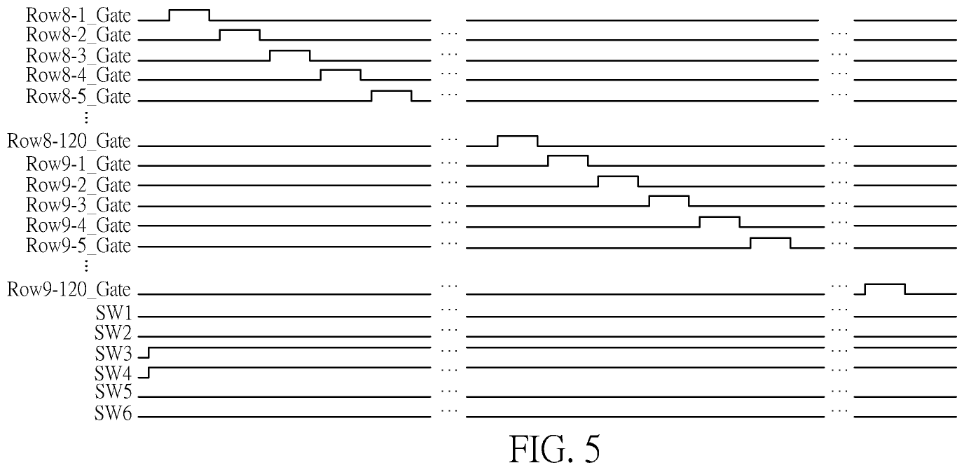

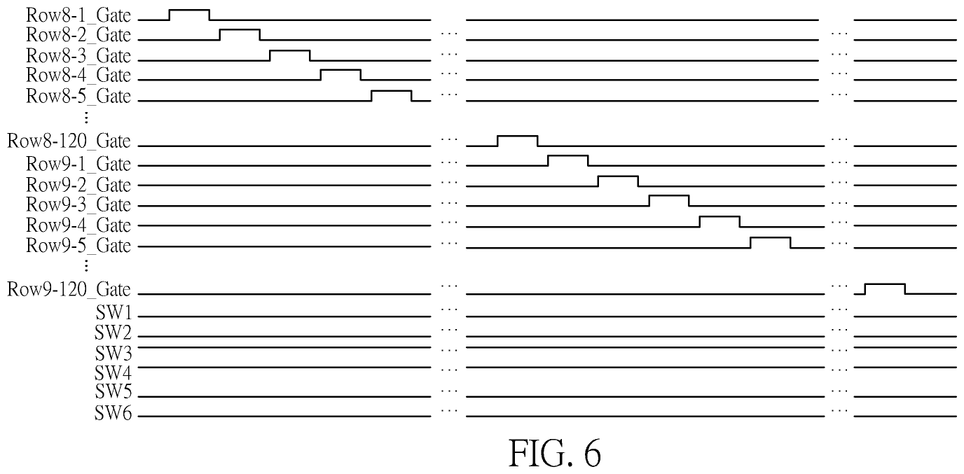

FIG. 5 is an illustration of first waveforms of the control signals SW1 to SW6 and scan line signals Row8-1_Gate to Row8-120_Gate, and Row9-1_Gate to Row9-120_Gate of the electronic device 100. FIG. 6 is an illustration of second waveforms of the control signals SW1 to SW6 and scan line signals Row8-1_Gate to Row8-120_Gate, and Row9-1_Gate to Row9-120_Gate of the electronic device 100. As previously mentioned (FIG. 1), the finger touch region FPR includes 4 regions (i.e., the regions A1 to the regions A4). The readout line groups corresponding to the finger touch region FPR are D3 and D4. Therefore, in FIG. 5, the fingerprint identification readout circuit ROIC can generate the control signals SW3 and SW4 having varied voltage level from “low voltage level” to “high voltage level” for enabling the multiplexer (i.e., turning on the transistors Z3 and Z4) so that the readout line groups D3 and D4 are enabled. The scan line signals Row8-1_Gate to Row8-120_Gate sequentially scan the region A1 and the region A2. Then, the scan line signals Row9-1_Gate to Row9-120_Gate sequentially scan the region A3 and the region A4. Therefore, for the finger touch region FPR, the electronic device 100 only needs a scan count=2 for completing the reception of fingerprint data. Similarly, in FIG. 6, the fingerprint identification readout circuit ROIC can generate the control signals SW3 and SW4 having high voltage levels for enabling the multiplexer (i.e., turning on the transistors Z3 and Z4) so that the readout line groups D3 and D4 are enabled. The scan line signals Row8-1_Gate to Row8-120_Gate sequentially scan the region A1 and the region A2. Then, the scan line signals Row9-1_Gate to Row9-120_Gate sequentially scan the region A3 and the region A4. Therefore, for the finger touch region FPR, the electronic device 100 only needs the scan count=2 for completing the reception of fingerprint data.

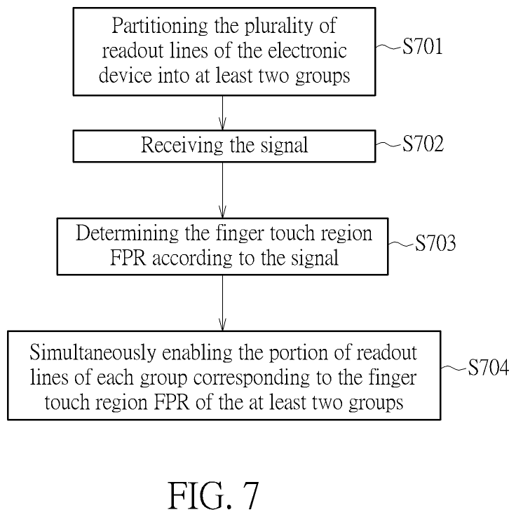

FIG. 7 is a flow chart of performing a fingerprint identification method by using the electronic device 100. The fingerprint identification method includes step S701 to step S704.

Any reasonable technology modification falls into the scope of the present disclosure. Step S701 to step S704 are illustrated below.
Step S701: partitioning the plurality of readout lines of the electronic device 100 into at least two groups;
Step S702: receiving the signal;
Step S703: determining the finger touch region FPR according to the signal;
Step S704: simultaneously enabling the portion of readout lines of each group corresponding to the finger touch region FPR of the at least two groups.

Details of step S701 to step S704 are previously described. Thus, they are omitted here. The electronic device 100 partitions the readout lines into at least two groups. Therefore, the electronic device 100 can scan at least two regions of the touch panel 10 at the same time. Therefore, the fingerprint identification readout circuit ROIC can simultaneously acquire fingerprint data corresponding to at least two regions through the readout lines, thereby reducing the number of scans and identification latency.

To sum up, the present disclosure describes a fingerprint identification method by using an electronic device and the electronic device having a fingerprint identification function. The electronic device can be applied to a touch panel or a display touch panel. The electronic device can partition a plurality of readout lines in an interlaced manner. Then, the electronic device can enable a portion of the readout lines. Further, the number of groups of readout lines can be customized. The electronic device can scan at least two regions of the touch panel at the same time. Therefore, the fingerprint identification readout circuit can simultaneously acquire fingerprint data corresponding to at least two regions through the readout lines, thereby reducing the number of scans, identification latency, and power consumption.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A fingerprint identification method by using an electronic device comprising:
partitioning a plurality of readout lines of the electronic device into at least two groups;
receiving a signal;
determining a finger touch region according to the signal; and
simultaneously enabling a portion of readout lines of each group corresponding to the finger touch region of the at least two groups.

2. The method of claim 1, further comprising:
enabling a plurality of scan lines which overlap the finger touch region;
wherein the plurality of scan lines are configured to identify a fingerprint feature.

3. The method of claim 1, wherein the plurality of readout lines are coupled to at least one multiplexer, and the at least one multiplexer is configured to select a part of readout lines of the plurality of readout lines of the at least two groups.

4. The method of claim 1, wherein the signal is a touch signal.

5. The method of claim 1, wherein the plurality of readout lines of the at least two groups are arranged in an interlaced manner.

6. The method of claim 1, further comprising:
outputting fingerprint information from the finger touch region to a fingerprint identification readout circuit through the portion of readout lines of the each group after a finger touches the finger touch region; and
identifying a fingerprint by using the fingerprint identification readout circuit according to the fingerprint information.

7. The method of claim 6, further comprising:
generating a synchronization signal from a touch panel driving circuit to the fingerprint identification readout circuit; and
controlling a display gate driving circuit for driving a plurality of scan lines by the touch panel driving circuit.

8. The method of claim 1, further comprising:
acquiring finger coordinates;
transmitting the finger coordinates to a touch panel driving circuit; and
transmitting the finger coordinates from the touch panel driving circuit to a fingerprint identification readout circuit through a host.

9. An electronic device capable of identifying fingerprint comprising:
a touch panel;
a plurality of scan lines coupled to the touch panel;
a plurality of readout lines coupled to the touch panel;
a plurality of driving circuits coupled to the plurality of readout lines and configured to selectively output fingerprint information; and
a fingerprint identification readout circuit coupled to the plurality of driving circuits and configured to identify a fingerprint;
wherein the plurality of readout lines are partitioned into at least two groups, the fingerprint identification readout circuit determines a finger touch region according to a signal after the fingerprint identification readout circuit receives the signal, and the fingerprint identification readout circuit simultaneously enables a portion of readout lines of each group corresponding to the finger touch region of the at least two groups.

10. The electronic device of claim 9, further comprising:
a circuit pack comprising at least one multiplexer and at least one de-multiplexer;
wherein the circuit pack is coupled to a touch panel driving circuit for driving the fingerprint identification readout circuit.

11. The electronic device of claim 10, further comprising:
a touch panel driving circuit coupled to the circuit pack and the fingerprint identification readout circuit; and
a display gate driving circuit coupled to the touch panel driving circuit and configured to drive a plurality of scan lines;
wherein a synchronization signal is generated from the touch panel driving circuit to the fingerprint identification readout circuit.

12. The electronic device of claim 9, wherein the plurality of scan lines which overlap the finger touch region are enabled, and the plurality of scan lines are configured to identify a fingerprint feature.

13. The electronic device of claim 9, wherein the plurality of readout lines are coupled to at least one multiplexer, and the at least one multiplexer is configured to select a part of readout lines of the plurality of readout lines from the at least two groups.

14. The electronic device of claim 9, wherein the signal is a touch signal.

15. The electronic device of claim 9, wherein the plurality of readout lines of the at least two groups are arranged in an interlaced manner.

16. The electronic device of claim 9, wherein the fingerprint information is outputted from the finger touch region to the fingerprint identification readout circuit through the portion of readout lines of the each group after a finger touches the finger touch region, and the fingerprint is identified by using the fingerprint identification readout circuit according to the fingerprint information.

17. The electronic device of claim 9, wherein after finger coordinates are acquired, the finger coordinates are transmitted to the fingerprint identification readout circuit through a host.
